(19) United States
(12) Patent Application Publication
(10) Pub. No.: US 2011/0114864 A1
(43) Pub. Date: May 19, 2011

(54) Watering Control Valve

(76) Inventor: Cheng-Hsuan Wu, Lugang Township (TW)

(21) Appl. No.: 12/618,857

(22) Filed: Nov. 16, 2009

(51) Int. Cl. F16K 1/00

(52) U.S. Cl. 251/321

(57) ABSTRACT

A watering control valve comprises a housing including two opposite elongated outlets fixed on a middle section of a peripheral side thereof; a shaft member inserted to the housing and an upper end thereof extends out of the housing; an upper ceramic member received in the housing and located at a lower side of the shaft member, and including two openings fixed on two symmetrical positions thereof, and including two recesses formed on a peripheral side thereof; a lower ceramic member contacting with the upper ceramic member and including two bores secured on two symmetrical positions thereof, and including two tabs formed on a peripheral side thereof to be retained in the housing; characterized in that the shaft member includes a watering chamber having a cavity to receive a spring, and includes a check element and a sealing pad installed therein.

### BACKGROUND OF THE INVENTION

1. Field of the Invention

The present invention relates to a watering control valve for an unfreezable tap that as water supply is stopped, water will not remain in the shaft member to be frozen, thus having a smooth water supply as the upper ceramic member is turned on again in a frozen zone.

2. Description of the Prior Art

A conventional unfreezable tap is installed outdoors to sprinkle water on the ground, and includes a watering control valve disposed therein and having a ceramic set to replace a conventional check copper element, thereby controlling water amount.

Referring to FIGS. 1-3, a conventional watering control valve for an unfreezable tap comprises a housing 10, a shaft member 20, an upper ceramic member 30, a lower ceramic member 40, a check element 50, a seat 60, a fitting loop 70, and a retaining piece 80, wherein the housing 10 includes an actuate first limiting projection 101 disposed on a side of a top end thereof, the shaft member 20 is inserted in the housing 10 and includes an actuating member 201 extendedly mounted on a bottom end thereof, and includes an inlet 202 fixed in a lower interior thereof and an outlet 203 formed on a peripheral side thereof, and includes an engaging section 204 arranged on a lower side thereof, a rotating portion 205 formed on an upper side thereof. The outlet 203, the engaging section 204, and the rotating portion 205 extend out of the housing 10, and the upper ceramic member 30 is received in the housing 10 and located the lower side of the shaft member 20, and includes a semicircular hole 301 disposed thereon, and two recesses 302 mounted on a peripheral side thereof to be retained to the actuating member 201 of the shaft member 20 so as to obtain an actuating state, the lower ceramic member 40 is received in the housing 10 and contacts with the upper ceramic member 30, and includes a semicircular aperture 401 fixed thereon, includes two tabs 402 formed on a peripheral side thereof to be retained in the housing 10, the check element 50 includes an inflow end 501 secured on a lower side thereof and an outflow end 502 arranged on an upper side thereof so that water flows out of the outflow end 502 from the inflow end 501 and does not flow backward. The seat 60 includes an inflow side disposed on a bottom thereof and a connecting portion 601 mounted on an upper side thereof to couple with the lower side of the housing 10, and includes a receiving room 602 to receive the check element 50, and the fitting loop 70 is fitted to an outer periphery of the shaft member 20, and includes a locking orifice 701 formed therein to engage with the engaging section 204 of the shaft member 20, and includes a second limiting projection 702 fixed on a peripheral side thereof to rotate the upper ceramic member 30 and the lower ceramic member 40 with the first limiting projection 101 of the housing 10, and the retaining piece 80 is engaged to a peripheral side of the shaft member 20 to retain the shaft member 20 in the housing 10.

In operation, the rotating portion 205 of the shaft member 20 is inserted to a controlling rod and connected with a lever of the controlling rod, when rotating the lever to start water supply, the shaft member 20 is rotated to actuate the upper ceramic member 30 to turn so that the hole 301 of the upper ceramic member 30 aligns with the aperture 401 of the lower ceramic member 40, and the check element 50 is opened by water, hence water flows to the outlet 203 of the shaft member 20 through the aperture 401 of the lower ceramic member 40 and the hole 301 of the upper ceramic member 30, obtaining water supply.

Because the check element 50 is disposed in the conventional watering control valve, water only flows to the outflow end 502 from the inflow end 501 without flowing backward, therefore the water remains in the shaft member 20 and the check element 50 that can not flow back to the inflow end 501, thus being frozen in a frozen day to jam the upper and the lower ceramic members 30, 40.

The present invention has arisen to mitigate and/or obviate the afore-described disadvantages.

### SUMMARY OF THE INVENTION

The primary object of the present invention is to provide a watering control valve that as water supply is stopped, the water will not remain in the shaft member to be frozen in a frozen zone, thus having a smooth water supply as the upper ceramic member is turned on again.

A watering control valve in accordance with a preferred embodiment of the present invention comprises:

a housing including a shaft member, an upper ceramic member, a lower ceramic member disposed therein, and including a seat mounted on a lower end thereof to fit a stopping member, wherein the housing includes two opposite elongated outlets fixed on a middle section of a peripheral side thereof, the shaft member is inserted to the housing and an upper end thereof extends out of the housing; the upper ceramic member is received in the housing and located at a lower side of the shaft member, and includes two openings fixed on two symmetrical positions thereof, and includes two recesses formed on a peripheral side thereof; the lower ceramic member contacts with the upper ceramic member and includes two bores secured on two symmetrical positions thereof, and includes two tabs formed on a peripheral side thereof to be retained in the housing; characterized in that:

the shaft member includes a watering chamber having a cavity to receive a spring, and includes a check element and a sealing pad installed therein, such that a water backward flowing is obtained by using the check element, the sealing pad, and the spring.

### BRIEF DESCRIPTION OF THE DRAWINGS

FIG. 1 is a perspective view showing the exploded components of a conventional watering control valve for an unfreezable tap;

FIG. 2 is a cross sectional view showing the assembly of the conventional watering control valve for the unfreezable tap;

FIG. 3 is a cross sectional view showing the operation of the conventional watering control valve for the unfreezable tap;

FIG. 4 is a perspective view showing the exploded components of a watering control valve according to a preferred embodiment of the present invention;

FIG. 5 is a perspective view showing the assembly of the watering control valve according to the preferred embodiment of the present invention;

FIG. 6 is a cross sectional view showing the assembly of the watering control valve according to the preferred embodiment of the present invention;

FIG. 7 is a cross sectional view showing the operation of the watering control valve according to the preferred embodiment of the present invention.

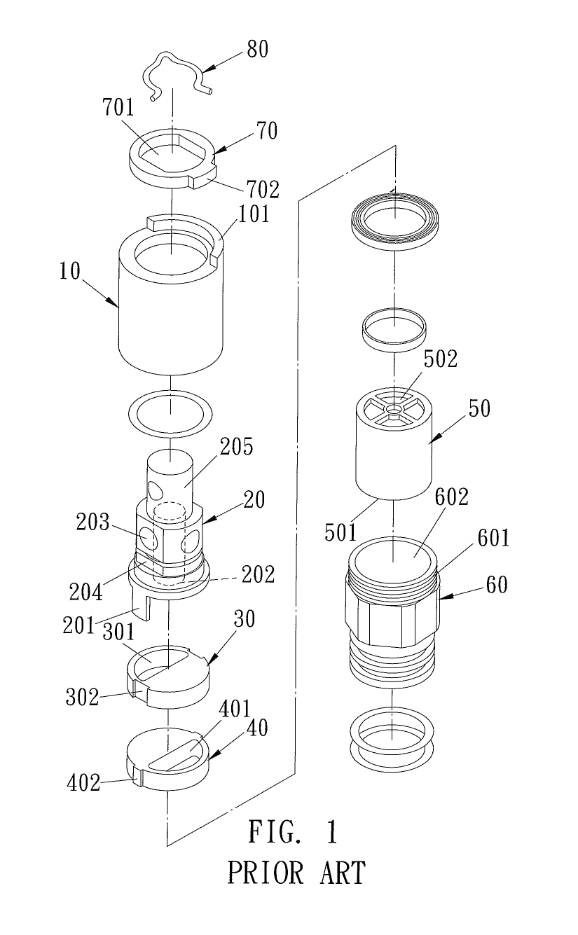

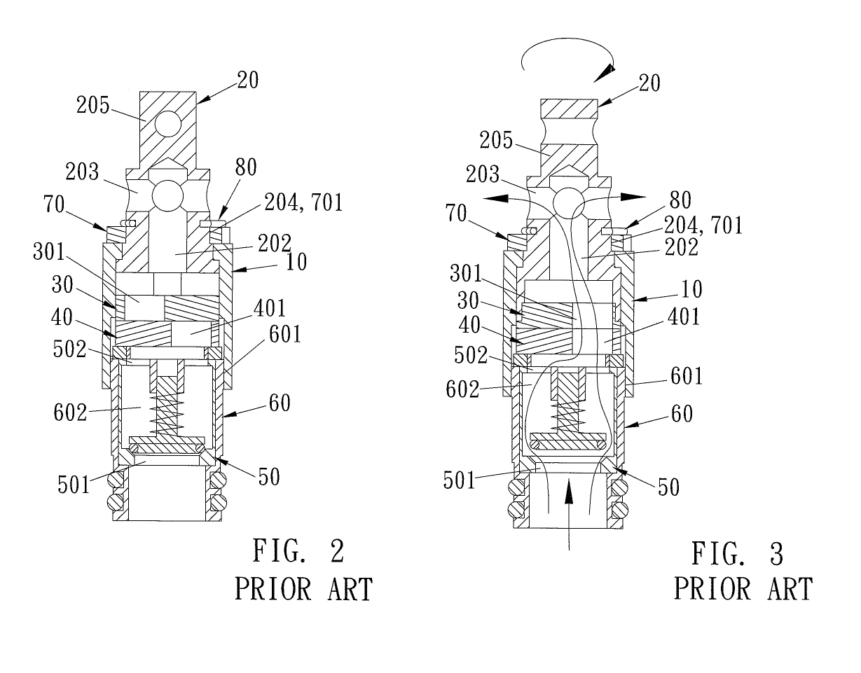

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

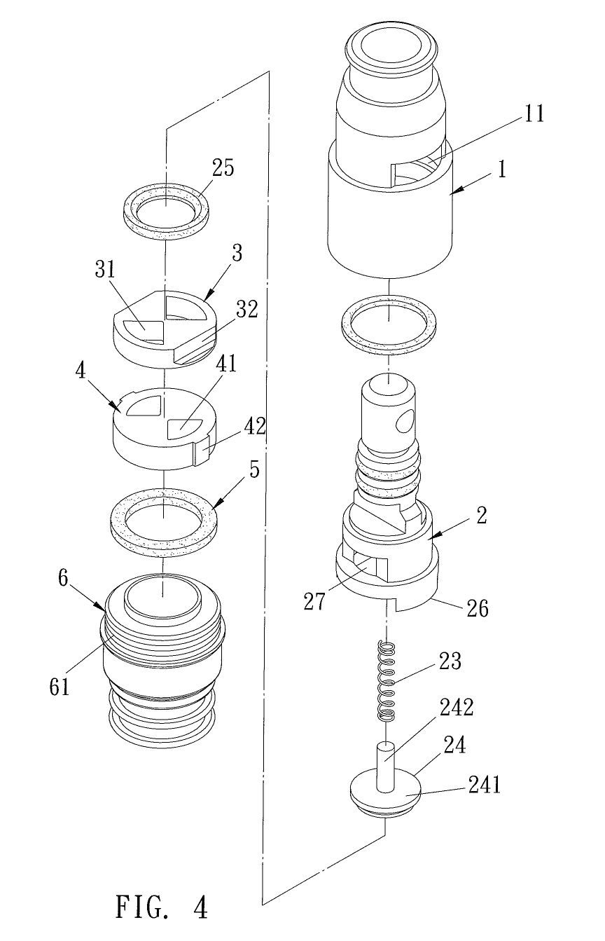

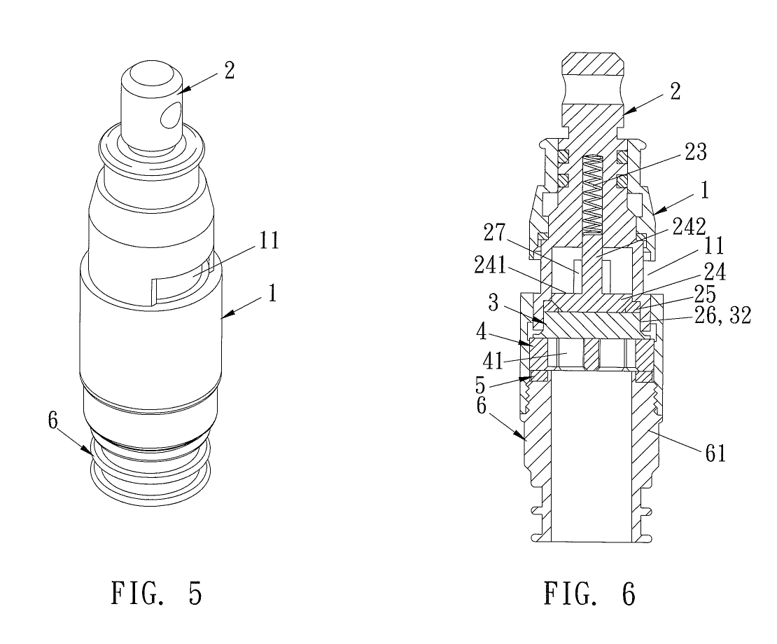

Referring to FIGS. 4-6, a watering control valve in accordance with a preferred embodiment of the present invention comprises: a housing 1 including a shaft member 2, an upper ceramic member 3, a lower ceramic member 4 disposed therein, and including a seat 6 mounted on a lower end thereof to fit a stopping member 5, wherein the housing 1 includes two opposite elongated outlets 11 fixed on a middle section of a peripheral side thereof, the shaft member 2 is inserted to the housing 1 and an upper end thereof extends out of the housing 1, and includes a watering chamber 21 secured on an interior of a lower end thereof, the watering chamber 21 includes a cavity 22 arranged on a top surface thereof to receive a spring 23, and includes a check element 24 and a sealing pad 25 installed therein, the check element 24 includes a disk-shaped plug 241 disposed on a bottom thereof, and the plug 241 includes a guiding pillar 242 extending upward from a top surface thereof and inserting to the cavity 22 of the housing 1 to abut against the spring 23; and the shaft member 2 includes two opposite actuating members 26 extendedly mounted on a bottom thereof, and includes two opposite apertures 27 fixed on a lower end of a peripheral side thereof; the upper ceramic member 3 is received in the housing 1 and located at a lower side of the shaft member 2 to abut against the sealing pad 25 of the watering chamber 21 of the shaft member 2 to obtain a water stopping state, and includes two ¼ circle of openings 31 fixed on two symmetrical positions thereof, and includes two recesses 32 formed on a peripheral side thereof to receive the actuating members 26 of the shaft member 2 respectively to form an actuating state; the lower ceramic member 4 is received in the housing 1 to contact with the upper ceramic member 3, and includes two ¼ circle of bores 41 secured on two symmetrical positions thereof, and includes two tabs 42 formed on a peripheral side thereof to be retained in the housing 1; the seat 6 includes an outflow end formed on a bottom thereof, and includes the stopping member 5 fitted on a top surface thereof, includes a connecting portion 61 arranged on an upper end thereof to couple with the lower end of the housing 1 so that the stopping member 5 is biased against the lower ceramic member 4 to achieve a water stopping state.

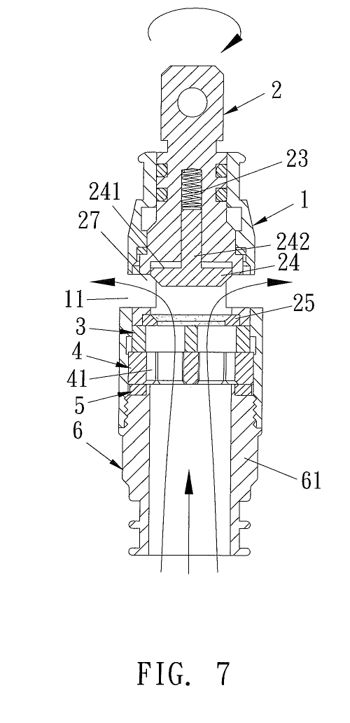

In operation, as shown in FIG. 7, the shaft member 2 is rotated by turning a lever of an unfreezable tap, and the actuating members 26 actuate the upper ceramic member 3 to rotate so that the openings 31 of the upper ceramic member 3 are in alignment with the bores 41 of the lower ceramic member 4, hence water flows into the outflow end of the seat 6 to push the check element 24 of the watering chamber 21 of the shaft member 2 upward through the bores 41 of the lower ceramic member 4 and the openings 31 of the upper ceramic member 3, such that the guiding pillar 242 of the check element 24 compresses the spring 23 upward, having a close state. Thereby, water flows to the outlets 11 of the housing 1 from the watering chamber 21 via the apertures 27 of the shaft member 2, having water supply.

In addition, if the lever of the unfreezable tap is rotated toward another direction to stop water supply, the shaft member 2 is actuated to rotate the upper ceramic member 3, and then the openings 31 of the upper ceramic member 3 are not in alignment with the bores 41 of the lower ceramic member 4 so that the water is stopped to flow through the bores 31 of the upper ceramic member 3, and the check element 24 is abutted against by the spring 23, the plug 241 contacts with the sealing pad 25 to stop water, and the water can not flow backward from the shaft member 2.

Thereby, the watering control valve of the present invention has the following advantages:

The unfreezable tap is installed in a frozen zone, therefore as water supply is stopped, water will not remain in the shaft member 2 to be frozen, having a smooth water supply as the upper ceramic member 3 is turned on again.

While we have shown and described various embodiments in accordance with the present invention, it is clear to those skilled in the art that further embodiments may be made without departing from the scope of the present invention.

What is claimed is:

1. A watering control valve comprising:
a housing including a shaft member, an upper ceramic member, a lower ceramic member disposed therein, and including a seat mounted on a lower end thereof to fit a stopping member, wherein the housing includes two opposite elongated outlets fixed on a middle section of a peripheral side thereof, the shaft member is inserted to the housing and an upper end thereof extends out of the housing; the upper ceramic member is received in the housing and located at a lower side of the shaft member, and includes two openings fixed on two symmetrical positions thereof, and includes two recesses formed on a peripheral side thereof; the lower ceramic member contacts with the upper ceramic member and includes two bores secured on two symmetrical positions thereof, and includes two tabs formed on a peripheral side thereof to be retained in the housing; characterized in that:
the shaft member includes a watering chamber having a cavity to receive a spring, and includes a check element and a sealing pad installed therein, such that a water backward flowing is obtained by using the check element, the sealing pad, and the spring.

2. The watering control valve as claimed in claim 1, wherein the watering chamber of the shaft member includes the cavity arranged on a top surface thereof.

3. The watering control valve as claimed in claim 1, wherein the check element includes a disk-shaped plug disposed on a bottom thereof, and the plug includes a guiding pillar extending upward from a top surface thereof and inserting to the cavity of the housing to abut against the spring.
